(19) United States
(12) Patent Application Publication
(10) Pub. No.: US 2009/0039181 A1
(43) Pub. Date: Feb. 12, 2009

(54) Cleaning Attachment for Water Hose

(76) Inventor: John Auer, JR., Cedar Creek, MO (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/226,149

(22) PCT Filed: Apr. 6, 2007
(86) PCT No.: PCT/US2007/008642

§ 371 Date: Oct. 9, 2008

Related U.S. Application Data
(60) Provisional application No. 60/791,203, filed on Apr. 12, 2006.

(51) Int. Cl. B05B 1/00

(52) U.S. Cl. 239/589

(57) ABSTRACT

The cleaning attachment (10) for use with a water hose (14) includes an angle adapter (20), a water control valve (30), a quick connect coupling (40, 42), a first thread adapter (60), a debris screen, a second thread adapter (70), a compression fitting adapter (80), and a hollow wand (90). The cleaning attachment (10) is designed to act as a nozzle for directing and dispensing water from a conventional water hose (14). Specifically, the cleaning attachment (10) is designed for effectively cleaning air conditioner coils, particularly condenser coils and evaporator coils. Cleaning attachment (10) allows a user to clean a coil with a flow of water through openings in the coil, eliminating the conventional need to disassemble the coil. The cleaning attachment (10) may also be used for a variety of other purposes for which a flow of pressurized water is needed.

### TECHNICAL FIELD

The present invention relates to cleaning devices, and, more specifically, to a cleaning attachment for use with a water hose.

### BACKGROUND ART

A variety of devices, including spray nozzles, have commonly been used for dispensing pressurized water from a flexible hose. Most of these spray nozzles are designed to assist the user in accomplishing everyday outdoor chores, such as watering flowers or plants, cleaning such surfaces as walls or driveways, or even cleaning such items as vehicles.

A need has long existed for a means for effectively cleaning air conditioner coils, especially condenser coils and evaporator coils. Due to the dimensions of these coils, cleaning them properly from the inside of the coils has always been a cumbersome task for air conditioning professionals and home owners wishing to properly maintain their air conditioning equipment. There is a need for a cleaning attachment for a water hose that will allow a user to clean a coil with a flow of water through openings in the coil, eliminating the need to disassemble the coil. Thus, a cleaning attachment for use with a water hose solving the aforementioned problems is desired.

### DISCLOSURE OF INVENTION

The disclosure is directed to a cleaning attachment for use with a water hose. The attachment includes a water control valve with opposing female and male ends. The female end of the water control valve is adapted for releasable connection to a water hose, and the male end is attached to a first threaded adapter. The first threaded adapter has opposing female and a male ends. The female end of the first threaded adapter is attached to the water control valve, and the male end has external pipe threads and is designed to connect to a second threaded adapter. The second threaded adapter has two opposing female ends. The first female end is releasably attached to the male end of the first threaded adapter, and an opposing second female end has internal pipe threads and is designed to connect to a compression fitting. The compression fitting connects the second threaded adapter to a hollow wand with opposed first and second ends. The second end of the hollow wand is closed, however the wand has an aperture formed adjacent to the closed second end so that the aperture forms a spray outlet.

The disclosure is also directed to a cleaning attachment that includes a mesh screen for filtering out particulate matter. The cleaning attachment has a water control valve that is releasably connected to a water hose. A hollow, elongated wand with a closed end is connected to the water control valve. A nozzle opening is formed adjacent to the closed end of the wand. A compression fitting is disposed between the wand and the water control valve. A mesh screen is disposed between the water control valve and the compression fitting. The water control valve, the compression fitting, and the wand form a water conduit for delivering water from the water hose to the nozzle opening so that the water sprays from the nozzle opening. The mesh screen filters out particulate matter from the water before the water is delivered to the wand.

### BRIEF DESCRIPTION OF THE DRAWINGS

FIG. 1 is an environmental, perspective view of a cleaning attachment for use with a water hose according to the present invention.

FIG. 2 is an exploded, side view of a cleaning attachment for use with a water hose according to the present invention.

FIG. 3 is an exploded, side view of an alternative embodiment of the cleaning attachment for use with a water hose according to the present invention.

Similar reference characters denote corresponding features consistently throughout the attached drawings.

### BEST MODES FOR CARRYING OUT THE INVENTION

The cleaning attachment for use with a water hose includes an angle adapter, a water control valve, a quick connect coupling, a first thread adapter, a second thread adapter, a compression fitting adapter, and a hollow wand. The angle adapter has a female end for connecting to the water hose and a male end. The water control valve has a female end for receiving the male end of the angle adapter and a male end. The quick connect coupling has a female member and a male member. The female member has a first end for receiving the male end of the water control valve and a second end for receiving a male quick connect extension and the male member has a first end with a male quick connect extension for engaging the second end of the female member and a second end having external hose threads.

The first thread adapter has a female end for receiving the second end of the male member of the quick connect coupling and a male end having external pipe threads. The second thread adapter has a first female end for receiving the male end of the first thread adapter and second female end having internal pipe threads. The compression fitting adapter has a male end for engaging the second female end of the second thread adapter and a female end for receiving a compression fitting. The hollow wand has a first end for engaging the female end of the compression fitting adapter and a second end, the second end of the hollow wand being crimped shut. An aperture is formed in the hollow wand at a point substantially near the second end of the hollow wand and is used for dispensing water through the cleaning attachment.

In an alternative embodiment, the cleaning attachment has a water control valve adapted for attaching directly to a garden hose, a mesh screen to filter particulate matter from the water stream, a compression fitting, and a hollow wand for emitting a spray of water. The water control valve is a swivel valve, permitting 360° axial rotation of the wand. The hollow wand is an elongated tube having a crimped end and an aperture through the tube sidewall defining a nozzle for spraying a jet of water from the wand. Adapters to adjust for thread type and size may be inserted between the components as needed.hrough openings in the coil, eliminating the need to disassemble the coil.

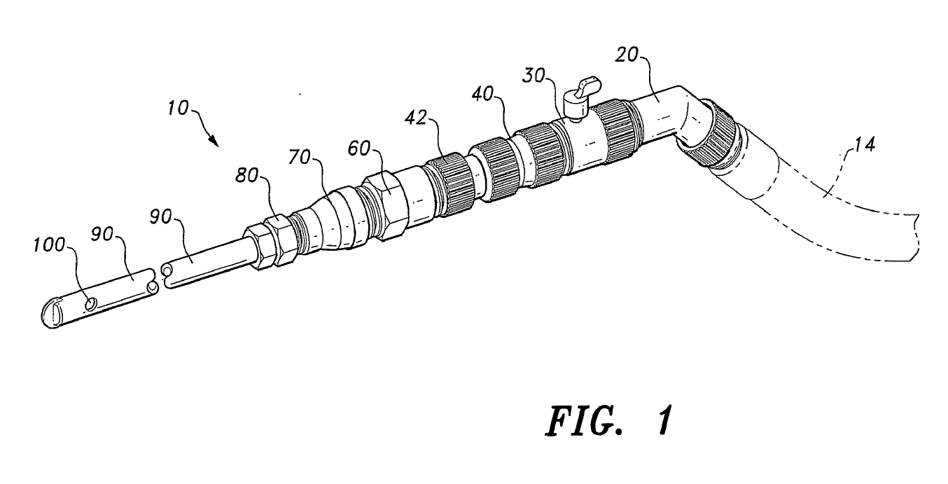

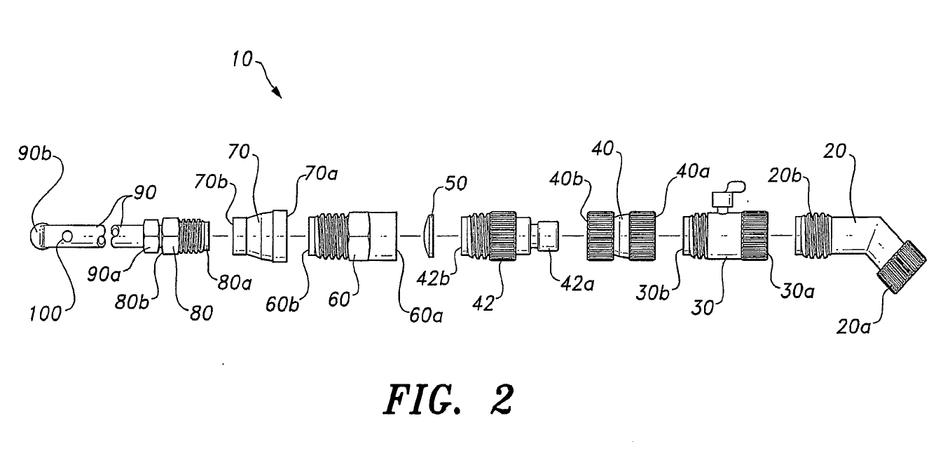

The present invention is designated generally as 10 in the drawings. Referring to FIGS. 1 and 2, cleaning attachment 10 is designed to act as a nozzle for directing and dispensing water from a conventional water hose 14. Specifically, cleaning attachment 10 is designed for effectively cleaning air conditioner coils, especially condenser coils and evaporator coils. Cleaning attachment 10 allows a user to clean a coil with a flow of water through the openings in the coil, eliminating the need to disassemble the coil.

Cleaning attachment 10 includes an angle adapter 20, a water control valve 30, a quick connect coupling, a first thread adapter 60, a second thread adapter 70, a compression fitting adapter 80, and a hollow wand 90. Angle adapter 20 has a female end 20a for attachment to a conventional water hose 14 and a male end 20b. Angle adapter 20 is provided to ergonomically ease the handling of cleaning attachment 10 and, in the preferred embodiment, angle adapter 20 is a 45° angle adapter.

Water control valve 30 is connected to angle adapter 20 and has a female end 30a for attachment to the male end 20b of angle adapter 20 and a male end 30b. Water control valve 30 is used to selectively control the flow of water through cleaning attachment 10 so that the pressure of water channeled to hollow wand 90 may be controlled by the user at a point adjacent attachment of the cleaning attachment 10 to the hose 14.

The quick connect coupling includes a female member 40 and a male member 42. Female member 40 has a first end 40a attached to the male end 30b of the water control valve 30 and a second female end 40b for receiving a male quick connect coupler. Male member 42 has a first end 42a with a male quick connect coupler for engaging the second end 40b of female member 40 and a second end 42b having external hose threads. Male member 42 and female member 40 are connectable so that, when connected, male member 42 is capable of rotating 360° with respect to female member 42. This quick connect coupling allows cleaning attachment 10 to be manipulated so that it can be more effective when cleaning air conditioning coils, providing the user with selectively adjustable rotation of hollow wand 90.

First thread adapter 60 is connected to male member 42 of the quick connect coupling and has a female end 60a attachable to the second end 42b of male member 42 of the quick connect coupling, and a male end 60b having external hose threads. First thread adapter 60 is designed to convert the hose threads of second end 42b into pipe threads that are present on male end 60b. In a preferred embodiment, first thread adapter 60 converts three-quarter inch hose threads into three-quarter inch pipe threads.

Further, in the preferred embodiment, debris screen 50 (shown in FIG. 2) is disposed between first thread adapter 60 and male member 42 of the quick connect coupling. Debris screen 50 prevents debris or particulate matter introduced into the system from reaching hollow wand 90. Second thread adapter 70 is connected to first thread adapter 60 and has a first female end 70a for attachment to the male end 60b of first thread adapter 60 and second female end 70b having internal pipe threads. In the preferred embodiment, second thread adapter 70 converts three-quarter inch pipe threads to one-half inch pipe threads.

Compression fitting adapter 80 is connected to second thread adapter 70 and has a male end 80a for engaging the second female end 70b of second thread adapter 70 and a female end 80b for receiving a compression fitting. Hollow wand 90 is connected to compression fitting adapter 80 and has a first end 90a for engaging the female end 80b of compression fitting adapter 80 and a second end 90b. The second end 90b of hollow wand 90 is crimped shut and hollow wand 90 is provided with an aperture 100 substantially near second end 90b. Aperture 100 is provided for directing and releasing water to be dispersed by cleaning attachment 10. In the preferred embodiment, hollow wand 90 is made from ⅜-inch outer-diameter stainless steel tubing and is two feet in length. It should be understood that the particular size and dimensions of wand 90 are dependent upon the particular needs and desires of the user. For example, the hollow wand 90 may have a ⅜-inch outer-diameter tubing, as above in the preferred embodiment, but the wand 90 may be formed with a length of three feet, for example.

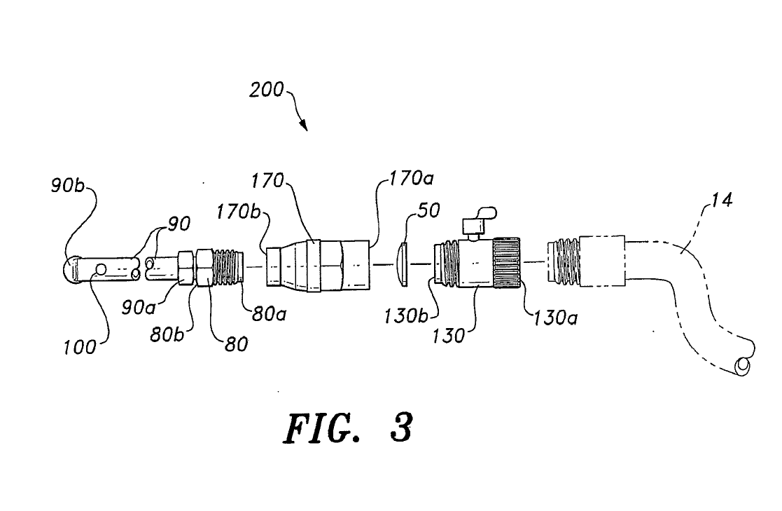

In the alternative embodiment of FIG. 3, cleaning attachment 200 is constructed substantially similar to attachment 10 of FIGS. 1 and 2. However the quick connect adapter formed from male portion 42 and female portion 40 has been removed. In order to provide the user with selective rotation of the wand 90 with respect to hose 14, water control valve 30 has been replaced with a swiveling water control valve 130 having a male threaded portion 130b and a female threaded portion 130a. Male portion 130b may be rotated axially 360° with respect to female portion 130a to direct the spray from the wand 90 in any desired direction.

In this embodiment, hose 14 is attached directly to female portion 130a, with angular adjuster 20 of FIGS. 1 and 2 being removed. Further, the first threaded adapter 60 and the second threaded adapter 70 have been replaced by a single threaded adapter 170 having first and second internally threaded female ends 170a, 170b. Preferably, the first end 170a of single threaded adapter 170 is selectively rotatable with respect to the second end 170b. The male portion 130b of valve 130 is attached to the first female end 170a of threaded adapter 170, and the threaded male end 80a of the compression fitting adapter 80 is attached to the second female end 170b. It should be understood that further elements may be removed or replaced, dependent upon the particular needs and desires of the user.

It is to be understood that the present invention is not limited to the embodiments described above, but encompasses any and all embodiments within the scope of the following claims.

1. A cleaning attachment for use with a water hose, comprising:
a water control valve having opposed female and male ends, the female end being adapted for releasable connection to the water hose;
a first threaded adapter having a female end for releasable connection to the male end of the water control valve, the first threaded adapter having an opposing male end, the male end having external pipe threads;
a second threaded adapter, the second threaded adapter having a first female end releasably attached to the male end of the first threaded adapter, and an opposing second female end having internal pipe threads;
a hollow wand having opposed first and second ends, the second end of the hollow wand being closed, the wand having an aperture formed therein adjacent the closed second end forming a spray outlet; and
a compression fitting attaching the wand to the second female end of the second threaded adapter.

2. The cleaning attachment as recited in claim 1, further comprising an angle adapter having a female connecting end and a male connecting end, the angle adapter being releasably connected between said water control valve and the water hose.

3. The cleaning attachment as recited in claim 2, wherein the male and female connecting ends of the angle adapter are each threaded.

4. The cleaning attachment as recited in claim 1, wherein the male end of the water control valve is selectively rotatable axially with respect to the female end thereof.

5. The cleaning attachment as recited in claim 1, further comprising a quick connect coupling disposed between the water control valve and the first threaded adapter.

6. The cleaning attachment as recited in claim 5, wherein the quick connect coupling includes a female member and a male member, the female member having a first end for receiving the male end of the water control valve and a second end for receiving a male quick connect extension of the male member, the male quick connect extension of the male member being formed at a first end thereof, the male member further a second end having external hose threads.

7. The cleaning attachment as recited in claim 6, further comprising a debris screen disposed between the first threaded adapter and the male member of the quick connect coupling.

8. The cleaning attachment for use with a water hose as recited in claim 1, further comprising a debris screen disposed between the first threaded adapter and the male end of the water control valve.

9. The cleaning attachment for use with a water hose as recited in claim 1, wherein said hollow wand is elongated and has a substantially linear contour.

10. A cleaning attachment for use with a water hose, comprising:
a water control valve adapted for releasable connection to the water hose;
a hollow, elongated wand having a closed end and a nozzle opening formed therein adjacent the closed end;
a compression fitting disposed between the wand and the water control valve; and
a mesh screen disposed between the water control valve and the compression fitting, the water control valve, the compression fitting, and the wand forming a water conduit for delivering water from the water hose in a spray from the nozzle opening, the mesh screen filtering particulate matter from the water before delivery to the wand.

11. The cleaning attachment according to claim 10, further comprising at lease one threaded adapter disposed between said water valve and said compression fitting for adapting thread types and fitting sizes.

12. The cleaning attachment as recited in claim 10, further comprising an angle adapter disposed between said water control valve and the water hose.

13. The cleaning attachment as recited in claim 10, wherein said water control valve comprises a swivel valve rotatable axially by about 360°.

14. The cleaning attachment as recited in claim 10, further comprising a quick connect coupling disposed between said water control valve and said compression fitting, the quick connect coupling being axially rotatable by about 360°.

15. The cleaning attachment as recited in claim 14, wherein the quick connect coupling includes a female member and a male member, the female member having a first end for receiving the male end of the water control valve and a second end for receiving a male quick connect extension of the male member, the male quick connect extension of the male member being formed at a first end thereof, the male member further a second end having external hose threads.
